(19) United States
(12) Patent Application Publication
(10) Pub. No.: US 2008/0083666 A1
(43) Pub. Date: Apr. 10, 2008

(54) System for Processing Contaminated Water

(75) Inventors: Carroll H. Brown, Loudon, TN (US); Carroll H. Brown, Knoxville, TN (US)

Correspondence Address: PITTS AND BRITTIAN P C, P O BOX 51295, KNOXVILLE, TN, 37950-1295, US

(73) Assignee: Industrial Chemical Solutions, Inc., Lenoir City, TN (US)

(21) Appl. No.: 11/538,992

(22) Filed: Oct. 5, 2006

(51) Int. Cl. B01D 15/00; B01D 15/04; B01D 21/01; C02F 9/00

(52) U.S. Cl. 210/202; 210/259; 210/266

(57) ABSTRACT

A system for processing contaminated water is disclosed. The system processes contaminated water, yielding water that is suitable for (1) re-use in an application (e.g., an industrial application) that requires water but does not require potable water, or (2) discharge (e.g., discharge into the environment), or (3) both (1) and (2).

All embodiments of the system include a separator for removing sediment and large suspended solids from contaminated water; a coagulant delivery device for delivering coagulant to contaminated water; a clarifying device for removing fine suspended solids from contaminated water; an adsorbing device for removing organic substances from contaminated water; a deashing device for removing dissolved inorganic salts from contaminated water; and a disinfecting device for destroying microorganisms present in contaminated water. Some embodiments of the present invention further include (1) an oil/water separator for removing oily matter from contaminated water and/or (2) a dewatering device.

### CROSS-REFERENCE TO RELATED APPLICATIONS

Not Applicable

### STATEMENT REGARDING FEDERALLY-SPONSORED RESEARCH OR DEVELOPMENT

Not Applicable

### FIELD OF THE INVENTION

The invention relates to a system for processing contaminated water to yield water that is suitable for (1) re-use in an application (e.g., an industrial application) that requires water but does not require potable water, or (2) discharge (e.g., discharge into the environment), or (3) both (1) and (2).

### BRIEF SUMMARY OF THE INVENTION

The present invention is a system for processing contaminated water (“system”). At least some embodiments of the system process contaminated water to yield water that is suitable for re-use in an application (e.g., an industrial application) that requires water but does not require potable water. These embodiments of the system prevent the accumulation of dissolved inorganic salts (among other contaminants) in the water as such water cycles repeatedly and successively through (1) the application and (2) the system. Accordingly, because dissolved inorganic salts are less likely to precipitate at low concentrations, these embodiments of the system reduce the possibility that the apparatuses used in the application will be fouled by precipitates (e.g., calcium carbonate). This reduces or eliminates the need to replace water that has been re-used several times or more with water that has not been used (e.g., fresh water from a municipal water source), which is sometimes referred to as “make-up water.” As suggested previously, at least some of these embodiments of the system can be used to process contaminated water generated by industry. The water yielded by these embodiments of the system is appropriate for re-use in many industrial applications, including some applications specific to either the automotive industry or electronics industry. Determining factors generally include (1) the initial concentration and identity of the contaminants in the contaminated water and (2) the requisite purity of the water needed for the application.

Other embodiments of the system process contaminated water to yield water that is suitable for discharge (e.g., discharge into the environment). Determining factors generally include (1) the initial concentration and identity of the contaminants in the contaminated water and (2) the environmental laws and regulations that control the discharge of used water in the jurisdiction of interest. At least some of these embodiments can be used to process contaminated water generated by industry, including the coal bed methane (CBM) extraction industry.

Finally, still other embodiments of the system process contaminated water to yield water that is suitable both for re-use in an application and for discharge.

All embodiments of the system include a separator for removing sediment and large suspended solids from contaminated water; a coagulant delivery device for delivering coagulant to contaminated water; a clarifying device for removing fine suspended solids from contaminated water; an adsorbing device for removing organic substances from contaminated water; a deashing device for removing dissolved inorganic salts from contaminated water; and a disinfecting device for destroying microorganisms present in contaminated water. Some embodiments of the present invention further include (1) an oil/water separator for removing oily matter from contaminated water and/or (2) a dewatering device.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1A is a block diagram that shows part of an embodiment 10 of the system for processing contaminated water; and

FIG. 1B is a block diagram that shows the remainder of the embodiment 10 of the system for processing contaminated water.

### DETAILED DESCRIPTION OF THE INVENTION

The present invention, i.e., the system for processing contaminated water, is described more fully hereinafter. From the outset, it is worth noting that this invention may be embodied in many different forms and should not be construed as limited to the specific embodiments described herein. Rather, the embodiments described herein are provided to ensure that this description is thorough and complete, and to ensure that the scope of the invention is communicated effectively to those skilled in the art. Finally, it is also worth noting that the Figures are provided merely as a guide to assist those skilled in the art in understanding and appreciating the scope of the invention.

### DEFINITIONS

“Activated carbon” refers to a powdered, granular, or pelleted form of amorphous carbon characterized by very large surface area per unit volume because of an enormous number of fine pores. It is also known as activated charcoal.

“Adsorption” refers to the surface retention of solid, liquid, or gas molecules, atoms, or ions by a solid or a liquid, as opposed to absorption (the penetration of substances into the bulk of the solid or liquid).

“Clarify” means to make (as a liquid) clear or pure usually by freeing from suspended matter.

“Clarity” refers to the measure of the amount of opaque suspended solids in a liquid, determined by visual or optical methods.

“Deashing” refers to a form of deionization in which inorganic salts are removed from solution by the adsorption of both the anions and cations by ion-exchange resins.

“Dewater” refers to the removal of water from solid material by wet classification, centrifugation, filtration or similar solid-liquid separation techniques.

“Free oil” refers to oil globules having a size greater than, or equal to, approximately 150 micrometers.

“Inorganic” means pertaining to, or composed of, chemical compounds that do not contain carbon as the principal element (excepting carbonates, cyanides, and cyanates).

“Oil” refers to any of various viscous, combustible, water-immiscible liquids that are soluble in certain organic solvents, as ether or naptha; may be of animal, vegetable, mineral, or synthetic origin; examples are fixed oils, volatile or essential oils, and mineral oils.

“Oily” means of, relating to, or consisting of, oil.

“Organic” means pertaining to, or composed of, chemical compounds that are based on carbon chains or rings and also containing hydrogen with or without oxygen, nitrogen, or other elements.

Other terms are defined as necessary in the detailed description that follows.

System for Processing Contaminated Water

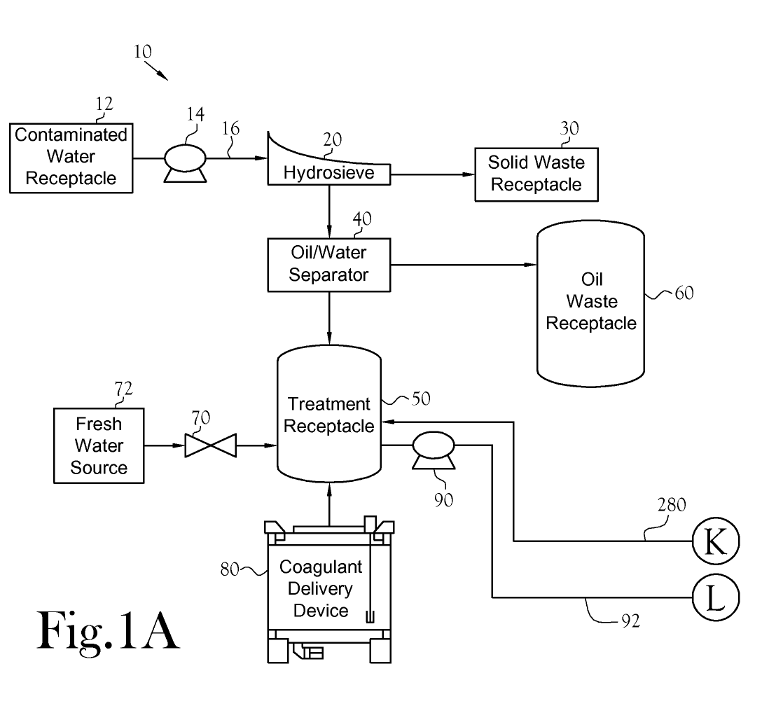

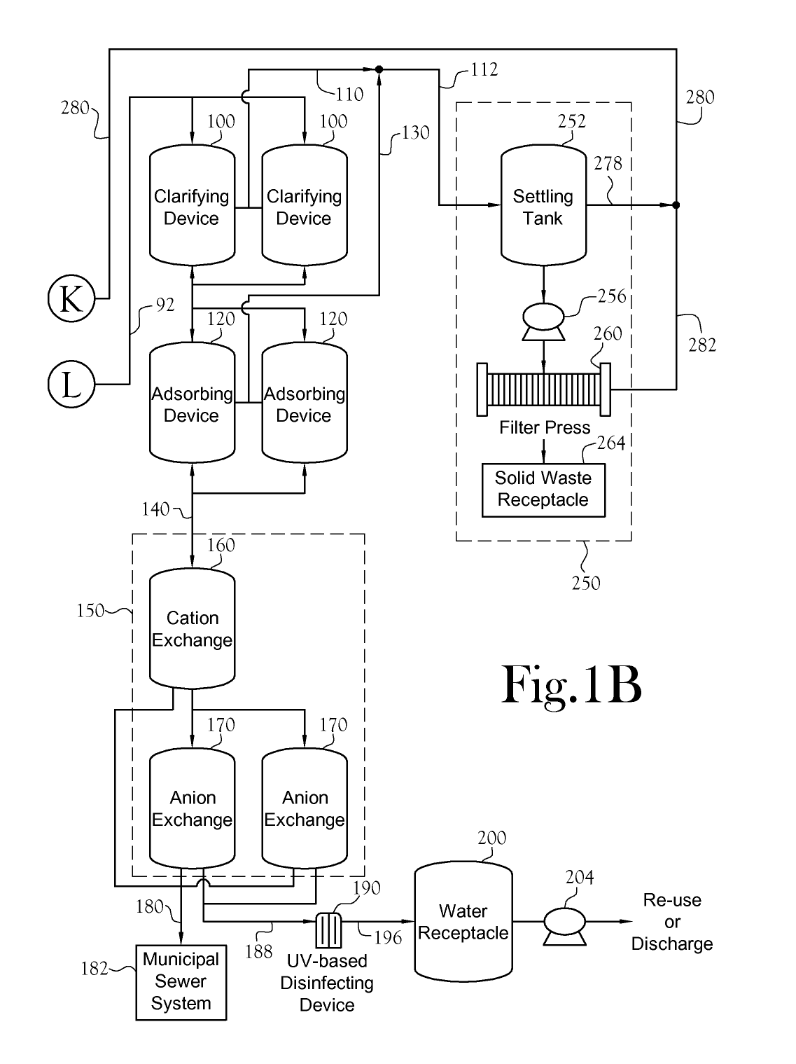

FIGS. 1A and 1B, together, show a block diagram of an embodiment 10 of the system for processing contaminated water (“system”). As shown in FIG. 1A, contaminated water is collected in the contaminated water receptacle 12, which is in fluid communication with the first pump 14. The first pump 14, when activated, aids in conducting the contaminated water (along arrow 16) from the contaminated water receptacle 10 to the separator 20. The separator 20 is included for separating sediment (if any) and large suspended solids from the contaminated water. In at least some embodiments, the separator 20 is a hydrosieve (as shown in FIG. 1A), a device used most commonly in applications where the large suspended solids at issue (1) can be separated from the suspending medium (liquid phase) without significant difficulty and (2) upon separation, can slide without significant difficulty to facilitate collection in a solid waste receptacle. In at least some of the embodiments of the system, the hydrosieve includes a screen that has slots having diameters ranging from to 3.175 millimeters to 0.254 millimeters. This hydrosieve potentially separates from the contaminated water all suspended solids having a size greater than, or equal to, approximately 0.254 millimeters (254 microns). The dimensions of the slots of the hydrosieve's screen, among other hydrosieve parameters, can be altered to optimize performance in a given application. One factor for consideration is the anticipated clarity of the contaminated water. Another factor for consideration is the respective capabilities and tolerances of the downstream devices (e.g., oil/water separators, clarifying devices, adsorbing devices, and disinfecting devices). The hydrosieve or other separator 20 should complement the capability of the downstream devices by reducing the concentration of large suspended solids to a tolerable level. If the separator 20 and downstream devices are not complementary, the capability of the downstream devices to remove contaminants from the contaminated water can be adversely affected. Additionally, at least some of the downstream devices can require more frequent maintenance (e.g., backwashing and regeneration) or replacement. As implied previously, the meaning of “large” in the context of suspended solids can vary depending on the application. For example, in some applications, including some of those where the contaminated water already has a high clarity, it may be advantageous for the separator 20 to separate from the contaminated water all suspended solids having a size greater than, or equal to, approximately 0.050 millimeters (50 microns). In some other applications, including some of those where the contaminated water has a low clarity, it may be advantageous for the separator 20 to separate from the contaminated water all suspended solids having a size greater than, or equal to, approximately 0.750 millimeters (750 microns). Depending on the application, it may be advantageous to use a device other than a hydrosieve (e.g., shaker screen, spin disk, or centrifugal/cyclonic separator) as the separator 20.

As shown in FIG. 1A, following the separation by the separator 20, the large suspended solids (and sediment) that have been removed from the contaminated water are collected for disposal in the first solid waste receptacle 30, and the contaminated water is collected in the oil/water separator 40. Oil/water separators are a class of “in-line” devices that are used to remove oily matter (e.g., grease and/or free oils) from contaminated water. Oil/water separators include (but are not limited to) any device that, upon receiving a mixture of oily matter and water, utilizes the difference in density between the oily matter and the water to separate one from the other. At least several types of oil/water separators are currently available, including (1) basic gravity oil/water separators, (2) enhanced gravity oil/water separators (e.g., coalescing oil/water separators and American Petroleum Institute (API) separators), and (3) centrifugal/cyclonic oil/water separators. Some oil/water separators remove via adsorption oily matter from contaminated water. In the embodiments of the system that include an oil/water separator 40, the residence time of the contaminated water in the oil/water separator 40 allows for the separation of the oily matter from the contaminated water. Thereafter, the oily matter is collected in the oil waste receptacle 60, and the contaminated water is conducted to the treatment receptacle 50.

As shown in FIG. 1A, the treatment receptacle 50 is in fluid communication with the coagulant delivery device 80, which is used to add coagulant as necessary to the contaminated water while it is present in the treatment receptacle 50. Coagulant delivery devices generally include (1) a metering device for providing a measured amount of coagulant for delivery and (2) a receptacle for storing coagulant. Regarding the present invention (the system), the coagulant delivery device 80 may include an injector for forcibly injecting the coagulant into the treatment receptacle 50 to ensure that the coagulant diffuses sufficiently throughout the contaminated water therein. However, an injector is not necessary in instances where the flow of the contaminated water, itself, is sufficient to achieve adequate diffusion of the coagulant. In such instances, a simpler device, such as a valve, may operate to allow coagulant to flow into the treatment receptacle 50. Coagulant is beneficial in that it encourages fine solids suspended in the contaminated water to collide with one another to form larger suspended masses known as flocs, which are easier to remove. Thus, the residence time of the contaminated water in the treatment receptacle 50 allows for adequate coagulation of fine suspended solids. Finally, if the amount of contaminated water being generated is insufficient to maintain an adequate level of pressure in the system, the valve 70 is opened to allow make-up water (e.g., fresh water from a municipal, well, or other water source) from the make-up water source 72 to flow into the treatment receptacle 50, thereby compensating for the shortfall. This can occur, for example, if the pressure in the system falls too low for either the clarifying device 100 (see FIG. 1B) or the adsorbing device 120 (see FIG. 1B) to continue operating efficiently.

As shown in FIGS. 1A and 1B, the treatment receptacle 50 is in fluid communication with the second pump 90, which is provided for aiding in the conduction (along arrow 92) of the contaminated water from the treatment receptacle 50 to the clarifying device 100 (see FIG. 1B). The pressure that is generated by the second pump 90 encourages the efficient removal of fine suspended solids by the clarifying device 100. In at least some embodiments of the present invention, the clarifying device 100 includes at least one depth filter. Such a filter can be used to remove suspended solids from liquids. A depth filter, as opposed to a surface filter or membrane filter, is a three-dimensional filter that retains contaminants (e.g., fine suspended solids) primarily within tortuous passages. By definition, a depth filter is able to retain contaminants throughout substantially its entire cross section, which defines, in the direction of fluid flow, either (1) at least one abrupt increase in density or (2) a graded increase in density. The increase in density allows relatively large suspended solids to be retained first, while allowing relatively small suspended solids to penetrate further into the cross-section until they are retained. For example, a depth filter suitable for removing fine suspended solids from contaminated water can have six (6) different layers of material, which when listed in the direction of fluid flow are as follows: (1) anthracite, (2) sand, (3) coarse garnet, (4) fine garnet, (5) coarse quartz, and (6) fine quartz. This combination can retain suspended solids down to a size ranging from approximately five (5) to approximately ten (10) microns. Those skilled in the art will recognize that other depth filters comprising multimedia are suitable for removing fine suspended solids from contaminated water. It is worth noting, however, that at least one manufacturer offers depth filters that do not comprise multimedia and are suitable for removing fine suspended solids from contaminated water. (General Electric Company offers depth filters that are manufactured using a one-step process involving the continuous extrusion and thermal bonding of polypropylene microfibers.) The composition, parameters, and requisite capability of the depth filter can vary significantly depending on a variety of factors, including (1) the initial clarity of the contaminated water, (2) the desired average flow rate of the contaminated water through the system, (3) the capability and/or efficiency of the separator 20, (4) the ability of other components of the system to tolerate suspended solids, and (5) any objective relating to the desired clarity of the product (i.e., water suitable for re-use and/or discharge).

Clarifying devices that include a depth filter generally are capable of at least two modes of operation: (1) service mode and (2) backwash mode. In service mode, the depth filter removes suspended solids from the contaminated water. These suspended solids, which are retained in the depth filter, accumulate therein. As the accumulation continues, the depth filter progressively clogs, eventually reducing the flow rate of the contaminated water. This can be evidenced by pressure loss. Additionally, solids can “break through” the filter, causing a decrease in water quality. In backwash mode, the depth filter is flushed by subjecting it to flow in the direction opposite that of the flow in service mode. In the embodiment shown in FIG. 1B, the backwash fluid consists of filtrate. However, other fluids may serve as backwash fluid, including, for example, fresh water, compressed air, an inert gas, or any combination thereof. Backwashing reclassifies the depth filter and is needed to prevent channeling and compaction. As shown in FIG. 1B, the used backwash fluid (including contaminants known to those skilled in the art as “sludge”) is conducted as indicated by arrows 110 and 112 to the dewatering device 250, which is described later in this detailed description.

In some embodiments of the system, including the embodiment shown in FIG. 1B, at least two clarifying devices 100, 100 (each including a depth filter) are arranged in parallel such that they can be backwashed sequentially. Such embodiments are advantageous in instances where, for example, there is a simultaneous or near simultaneous loss of pressure through at least two depth filters. In such instances (barring exigent circumstances), while one depth filter is being backwashed, the remaining depth filters are continuing to process contaminated water, thus reducing interruptions in the processing of the contaminated water.

As shown in FIG. 1B, following clarification by the clarifying device 100, the contaminated water is conducted to the adsorbing device 120, which commonly includes an activated carbon filter. Activated carbon is effective in retaining organic substances. Accordingly, the adsorbing device 120 is effective, in removing from contaminated water, water-soluble (dissolved) organic substances and emulsified organic substances (including emulsified oils), among other organic substances. It is worth noting that activated carbon is effective also in retaining non-polar inorganic substances. While there is complementarity among the separator 20, oil/water separator 40, clarifying device 100, and adsorbing device 120, there commonly is some redundancy between the oil/water seperator 40 and the adsorbing device 120 in that the latter 120 can adsorb oils remaining in the contaminated water following processing by the former 40.

Adsorbing devices that include an activated carbon filter generally are capable of at least two modes of operation: (1) service mode and (2) backwash mode. In this regard, they are similar to clarifying devices that include a depth filter. During service mode, the activated carbon filter removes contaminants from the contaminated water and retains them. As more contaminants are retained, the effectiveness of the activated carbon filter progressively decreases. This decrease is evidenced by a decline in performance and/or by pressure loss through the activated carbon filter. Such a filter is regenerated by backwashing to redistribute the carbon, thereby exposing a greater percentage of the remaining unspent carbon to the flow of contaminated water. Because the adsorption of at least some organic contaminants by the carbon is not reversible under practical conditions, the activated carbon filter usually is replaced periodically.

In the embodiment shown in FIG. 1B, the backwash fluid for the adsorbing device 120 consists of filtrate, as did the backwash fluid for the clarifying device 100. Similarly, those skilled in the art will recognize that other fluids (e.g., fresh water) may serve as backwash fluid for the adsorbing device 120. As shown in FIG. 1B, the used backwash fluid (including contaminants known to those skilled in the art as “sludge”) from the adsorbing device 120 is conducted to the dewatering device 250, as indicated by arrows 130, 112. In some embodiments of the system, including the embodiment shown in FIG. 1B, at least two adsorbing devices 120, 120 (each including an activated carbon filter) are arranged in parallel such that they can be backwashed sequentially. Thus, one of the adsorbing devices can be backwashed while the remaining adsorbing devices are in service mode, thereby reducing interruptions in the processing of the contaminated water.

Following processing by the adsorbing device 120, the contaminated water is conducted (as indicated by arrow 140) to the deashing device 150. Deashing devices remove inorganic salts from solution using ion-exchange resins. The use, in series, of a cation-exchange resin having only hydrogen (H⁺) ions available for exchange 160 and an anion-exchange resin having only hydroxide (OH⁻) ions available for exchange 170 allows for the removal of all the ionic species commonly present in contaminated water. (In limited circumstances, the contaminated water may be passed instead through a mixed bed of ion-exchange resins that includes both anion- and cation-exchange resins.) When the cation-exchange resin 160 is exhausted, it is regenerated by flushing it with an acidic solution (e.g., hydrochloric acid), and when the anion-exchange resin 170 is exhausted, it is regenerated by flushing it with a basic solution (e.g., sodium hydroxide). Following regeneration, the spent acidic solution (which now includes cationic contaminants retained by the cation-exchange resin) and the spent basic solution (which now includes anionic contaminants retained by the anion-exchange resin) are removed (displaced) by rinsing the respective resin beds with an aqueous liquid, in accordance with protocols known to those skilled in the art. The spent acidic solution, the spent basic solution, and any aqueous liquid used in rinsing the resin beds are conducted (as represented by arrow 180) such that they are discharged into the municipal sewer system 182, thereby preventing the accumulation of dissolved inorganic salts in the water as such water cycles repeatedly and successively through (1) the application and (2) the system. Although these liquids potentially include high concentrations of total dissolved solids (e.g., dissolved inorganic salts), current environmental laws and regulations in most jurisdictions neither limit the discharge of total dissolved solids nor discourage their discharge through impact fees or other penalties. It is worth noting, however, that the environmental laws and regulations controlling the disposal of water accumulated in the course of coal bed methane (CBM) extraction are rapidly evolving and commonly are more stringent in this regard. Thus, in most jurisdictions and in regard to most applications, the system can eliminate dissolved inorganic salts from contaminated water without any foreseeable penalty. Furthermore, in those embodiments of the system that process contaminated water to yield water that is suitable for re-use in an application, the possibility that apparatuses (e.g., water heaters) used in the application will be fouled by precipitates such as calcium carbonate (CaCO₃) is reduced because dissolved inorganic salts are less likely to precipitate at low concentrations.

The deashing device 150 usually is backwashed regularly to loosen up the resin beds, which can become too compacted over time. Backwashing is also performed to prevent (or reduce) channeling. Accordingly, deashing devices typically are capable of operating in at least three modes: (1) service, (2) backwash, and (3) regeneration. Generally, the performance of the deashing device 150 is monitored by measuring the conductivity of the contaminated water as it is exiting the anion-exchange resin 170. High conductivity indicates that either (or both) of the resin beds needs to be backwashed and/or regenerated. In some embodiments of the system, including the embodiment shown in FIG. 1B, two or more anion-exchange resins 170,170 are arranged in parallel to increase the performance of the system in some applications and/or to enable the sequential backwashing and regeneration of the resin beds. Likewise, in some embodiments of the system, two or more cation-exchange resins are arranged in parallel.

Following processing by the deashing device 150, the contaminated water is conducted (as indicated by arrow 188) to a disinfecting device 190. This device 190 destroys microorganisms living in the contaminated water, thereby completing the system's processing of the contaminated water to yield water that is suitable for re-use in an application and/or for discharge. In some embodiments of the system, including the embodiment shown in FIG. 1B, the disinfecting device 190 includes an ultraviolet (UV) lamp for generating an intense ultraviolet light having a wavelength that is deadly to microorganisms. Disinfecting devices that use only UV light to disinfect water do not generate disinfection byproducts, and this is advantageous in many instances. In other embodiments of the system, the disinfecting device 190 includes an ozone generator. The ozone generated therein is injected or bubbled into the contaminated water, where it destroys microorganisms. Disinfecting devices that use only ozone to disinfect water do not generate disinfection byproducts, either. In still other embodiments of the system, the disinfecting device 190 delivers controlled amounts of one or more disinfectants that comprise the element chlorine (e.g., chlorine gas, sodium hypochlorite, and chloramines). Aside from these aforementioned disinfecting devices (i.e., UV-based, ozone-based, and chlorine-based), other types of disinfecting devices may be suitable for some applications.

Following processing by the disinfecting device 190, the water is conducted (as represented by arrow 196) to the water receptacle 200 and stored therein for eventual re-use and/or discharge. As shown in FIG. 1B, the third pump 204, which is in fluid communication with the water receptacle 200, is included to aid in conducting the water to its next destination for re-use and/or discharge.

As stated previously, the used backwash fluid (including contaminants known to those skilled in the art as “sludge”) from the clarifying device 100 and from the adsorbing device 120, is conducted to the dewatering device 250, a device included in at least some embodiments of the system. In the embodiment shown in FIG. 1B, the dewatering device 250 includes the settling tank 252, the third pump 256, the filter press 260, and the second solid waste receptacle 264. The third pump 256 is in fluid communication with the settling tank 252 and the filter press 260. The used backwash fluid enters the settling tank 252, where the sludge component of the used backwash fluid settles by gravity. After the sludge settles, it is conducted with the aid of the third pump 256 to the filter press 260. Periodically, at least some of the used backwash fluid remaining in the settling tank 252 is conducted along arrows 278, 280 into the treatment receptacle 50 for processing along with other contaminated water. The filter press 260 generally includes a metal frame on which rigid plates are attached. The sludge is pumped into an accordion-shaped filter that is mounted between the rigid plates, which are then pressed together using a screw device, hydraulic device, or similar device. This action, in providing the pressure for filtration, separates any remaining used backwash fluid from the sludge, yielding only used backwash fluid and solid waste. This used backwash fluid is conducted (along arrows 282 and 280) into the treatment receptacle 50 for processing. The solid waste is deposited in the second solid waste receptacle 264 for later disposal.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants general inventive concept.

Having thus described the aforementioned invention, what is claimed is:

1. A system for processing contaminated water, said system comprising:
a separator for removing sediment and large suspended solids from contaminated water;
a coagulant delivery device for delivering coagulant to contaminated water;
a clarifying device for removing fine suspended solids from contaminated water;
an adsorbing device for removing organic substances from contaminated water;
a deashing device for removing dissolved inorganic salts from contaminated water; and
a disinfecting device for destroying microorganisms present in contaminated water.

2. The system of claim 1 further including an oil/water separator for removing oily matter from contaminated water.

3. The system of claim 1 further including a dewatering device, said dewatering device being in fluid communication with said clarifying device.

4. The system of claim 1 further including a dewatering device, said dewatering device being in fluid communication with said adsorbing device.

5. The system of claim 2 further including a dewatering device, said dewatering device being in fluid communication with said clarifying device.

6. The system of claim 2 further including a dewatering device, said dewatering device being in fluid communication with said adsorbing device.

7. A system for processing contaminated water, said system comprising:
a separator for removing sediment and large suspended solids from contaminated water;
a treatment receptacle for receiving contaminated water from said separator;
a coagulant delivery device for delivering coagulant to contaminated water present in said treatment receptacle;
a clarifying device in fluid communication with said treatment receptacle, said clarifying device for removing fine suspended solids from contaminated water received from said treatment receptacle;
an adsorbing device in fluid communication with said clarifying device, said adsorbing device for removing organic substances from contaminated water received from said clarifying device;
a deashing device in fluid communication with said adsorbing device, said deashing device for removing dissolved inorganic salts from contaminated water received from said adsorbing device; and
a disinfecting device in fluid communication with said deashing device, said disinfecting device for destroying microorganisms present in contaminated water received from said deashing device.

8. The system of claim 7 further including a dewatering device, said dewatering device being in fluid communication with said clarifying device.

9. The system of claim 7 further including a dewatering device, said dewatering device being in fluid communication with said adsorbing device.

10. The system of claim 7 wherein said separator is a hydrosieve.

11. The system of claim 7 wherein said clarifying device includes at least one depth filter.

12. The system of claim 7 wherein said adsorbing device includes at least one filter that comprises activated carbon.

13. The system of claim 7 wherein said deashing device includes at least one cation-exchange resin bed.

14. The system of claim 7 wherein said deashing device includes at least one anion-exchange resin bed.

15. The system of claim 7 wherein said disinfecting device includes an ultraviolet (UV) lamp.

16. The system of claim 8 wherein said dewatering device includes a filter press.

17. The system of claim 9 wherein said dewatering device includes a filter press.

18. A system for processing contaminated water, said system comprising:
a separator for removing sediment and large suspended solids from contaminated water;
an oil/water separator for removing oily matter from contaminated water received from said separator;
a treatment receptacle in fluid communication with said oil/water separator, said treatment receptacle for receiving contaminated water from said oil/water separator;
a coagulant delivery device for delivering coagulant to contaminated water present in said treatment receptacle;
a clarifying device in fluid communication with said treatment receptacle, said clarifying device for removing fine suspended solids from contaminated water received from said treatment receptacle;
an adsorbing device in fluid communication with said clarifying device, said adsorbing device for removing organic substances from contaminated water received from said clarifying device;
a deashing device in fluid communication with said adsorbing device, said deashing device for removing dissolved inorganic salts from contaminated water received from said adsorbing device; and
a disinfecting device in fluid communication with said deashing device, said disinfecting device for destroying microorganisms present in contaminated water received from said deashing device.

19. The system of claim 18 further including a dewatering device, said dewatering device being in fluid communication with said clarifying device.

20. The system of claim 18 further including a dewatering device, said dewatering device being in fluid communication with said adsorbing device.

21. The system of claim 18 wherein said separator is a hydrosieve.

22. The system of claim 18 wherein said clarifying device includes at least one depth filter.

23. The system of claim 18 wherein said adsorbing device includes at least one filter that comprises activated carbon.

24. The system of claim 18 wherein said deashing device includes at least one cation-exchange resin bed.

25. The system of claim 18 wherein said deashing device includes at least one anion-exchange resin bed.

26. The system of claim 18 wherein said disinfecting device includes an ultraviolet (UV) lamp.

27. The system of claim 19 wherein said dewatering device includes a filter press.

28. The system of claim 20 wherein said dewatering device includes a filter press.
